(19) United States
(12) Patent Application Publication
(10) Pub. No.: US 2008/0098116 A1
(43) Pub. Date: Apr. 24, 2008

(54) Method For Establishing a Multimedia Connection

(75) Inventor: Klaus Hoffmann, München (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, München (DE)

(21) Appl. No.: 11/661,815

(22) PCT Filed: Sep. 28, 2005
(86) PCT No.: PCT/EP05/54892

§ 371 Date: Mar. 1, 2007

(30) Foreign Application Priority Data
Sep. 28, 2004 (DE) 10 2004 047 025.1

(51) Int. Cl. G06F 15/16

(52) U.S. Cl. 709/227

(57) ABSTRACT

In one aspect, a method for establishing a multimedia connection between at least one calling user and at least one called user via packet-oriented computer networks is provided. The users independently recognize contradictory requests of the calling user and the called user to each other and then send a request for delaying execution of the respective task to the respective call partner if contradictory requests occur.

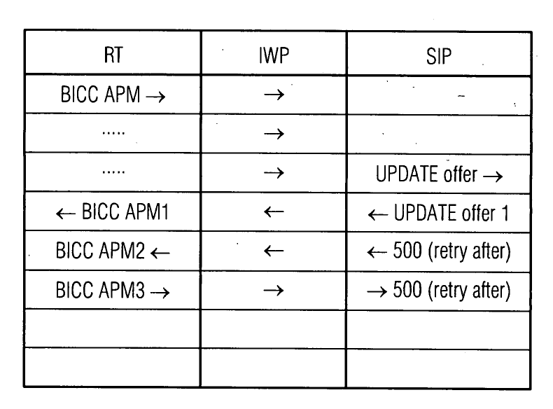

The invention relates to a method for establishing a multimedia connection.

In recent years, computer networks have developed to become an important communication medium via which a multiplicity of services are offered. The best-known computer network in the world is the Internet, this being the name given to the totality of all networks that are interconnected and use the Internet Protocol IP as a transport protocol.

The Internet Protocol IP at level 3 of the OSI layered model is responsible for the connectionless transport of data from a sender—possibly over a plurality of networks—to the recipient, providing neither error detection nor error correction.

Transport protocols such as the Transmission Control Protocol TCP or User Datagram Protocol UDP are situated above the Internet Protocol, and then above these comes an almost limitless multiplicity of different and sometimes competing application protocols such as http and FTP, for example, or (for the management of multimedia connections) the so-called SIP protocol or the ITU standard H.323.

With regard to multimedia connections in the Internet, there are currently two competing standards for signaling: H.323 and SIP. The ITU standard H.323 (ITU: International Telecommunication Union) was developed for the realtime transmission of multimedia applications such as voice and video communication in packet-oriented networks. As a so-called umbrella standard, it comprises a range of protocols for e.g. signaling, exchanging terminal functionalities and status information, and for connection control and data flow control. H.225, H.245 and H.450.x are among the most important protocols of the H.323 standard. H.225 describes signaling protocols such as RAS (Registration, Admission, Status) and call signaling. H.245 functions as a control protocol for multimedia communication. The H.450 standard defines additional telephony functions, in order to reproduce the performance features of ISDN on IP, for example.

For the case of a multimedia connection, wherein establishing the basic channel (also called bearer or bearer channel) and signaling (call) take place separately, the means whereby known services can be implemented are defined in parallel and alternatively by the ITU-T standard Q.1902.XBICC CS2 (bearer independent call control capability set 2) and Q.765.5 BAT (bearer application transport).

The Session Initiation Protocol SIP was developed by the IETF (Internet Engineering Task Force). The standard defines a signaling protocol for establishing, modifying and terminating sessions involving two or more subscribers. The Session Initiation Protocol SIP is also used for the transmission of realtime data over packet-based networks and is functionally comparable with the protocols defined in ITU standard H.323: the Session Initiation Protocol SIP can negotiate interactive communication services including voice over IP networks; the transport functions via TCP (Transmission Control Protocol) or UDP (User Datagram Protocol). In this case, the Session Initiation Protocol SIP is responsible for the voice signaling and for the localization and registration of users. In particular, however, it also allows the caller identity to be transferred and call forwarding in IP networks. The Session Initiation Protocol SIP is text-oriented, based on HTTP (Hypertext Transfer Protocol), and therefore offers an open Internet-based structure. Consequently, new performance features can be implemented relatively simply and quickly.

The two cited standards are continually being developed further. Recent examples include Q.1912.5 “Interworking SIP and BICC/ISUP” for ITU-T and RFC 3366 “SIP basic call flow examples” for IETF.

Despite every effort on the part of standardization bodies, it is still not possible to reproduce all performance features of ISDN on connections via packet-switching computer networks without conflict.

The invention therefore addresses the problem of further developing multimedia connections in accordance with the cited standards.

According to the invention, this problem is solved by means of a method for establishing a multimedia connection over packet-switching computer networks between at least one calling subscriber and at least one called subscriber, wherein if contradictory requirements are sent by calling and called subscriber to each other, the subscribers independently detect these contradictory requirements and consequently send the respective call partner a request for delayed execution of the corresponding task.

In a simple manner, the invention resolves a conflict which is produced by contradictory requirements of two subscribers on a connection. For example, this case occurs if e.g. the calling subscriber activates the performance feature “CALL Transfer” and the called subscriber activates a feature from the “CALL Forwarding” group. In these cases, for reasons of network loading, it is desirable for the basic channel of the connection to be routed via a direct path between the newly included subscribers.

In this context, the term subscriber designates not just people but also automatic systems of all types, e.g. call answering systems and automatic application programs (applications) which can exchange multimedia messages.

The invention can be implemented to particular advantage if the two subscribers belong to domains having different signaling protocols. In this case, the signaling messages for establishing a connection are routed via interworking points which perform a translation between the protocols of the signaling requests.

In principle, any type of information transmission is conceivable as a multimedia connection in this context. Clearly, however, the transmission of voice, fax or data transmission via modem are particularly important.

The invention is explained in greater detail with reference to an exemplary embodiment which is illustrated schematically in the figure.

In the form of an extract, the figure shows a call being established between a calling subscriber SIP, which has an ISDN connection interface in the exemplary embodiment and wishes to establish a call connection to a further subscriber SIP.

The ISDN device of the caller RT uses ISDN User Part (ISUP) signaling.

The ISDN User Part is one of a plurality of possible user parts (UP) of SS7 signaling. It is the ISDN-specific portion in the transmission of supplementary information over the signaling channel between exchanges and the prerequisite for a complete range of ISDN services, even in the context of international traffic. By contrast, the called subscriber SIP is a device which is connected to a computer network. In this network, the Bearer Independent Call Control (BICC) and the Session Initiation Protocol SIP described in the introduction are used as signaling protocols.

Since the two subscribers RT, SIP therefore “speak different languages”, a connection via a so-called interworking unit IWP is necessary. This interprets and translates the ISUP signaling elements into BICC to produce SIP commands and vice versa.

In the exemplary embodiment, so-called outband signaling takes place, i.e. basic channel and signaling are routed via separate paths. For this, e.g. the ITU-T standard Q.1902.X BICC CS2 (bearer independent call control capability set 2) and Q.765.5 BAT (bearer application transport) define how known services can be implemented.

However, the prior art does not provide a solution for e.g. the case of BICC-SIP interworking in which the calling subscriber has activated the performance feature “CALL Transfer” and the called subscriber has activated a feature from the “CALL Forwarding” group.

In the case of “Call Forwarding”, calls are immediately forwarded to any desired but available telephone connection interface. However, the basic channels leading to the subscriber should remain free in this case, i.e. the basic channel should not be routed via the device on which “Call Forwarding” has been activated.

The performance feature “CALL Transfer” allows the transfer of a call to a third party, and again in this case the basic channels leading to the device of the eliminated subscriber should no longer be loaded after the call transfer.

Both features now require a rerouting of the basic channel via a direct path between the newly included subscribers.

As described in the prior art, both subscribers will now send the respective communication partner, according to the relevant valid signaling protocol, the request BICC APM as per ITU-T Q.1902.6 “BICC CS2: Generic signaling procedures for the support of ISDN supplementary services and for bearer redirection” and UPDATE SDP (Session Description Protocol, RFC 2327) offer as per IETF RFC 3311/RFC 3264, signaling that the basic channel should now be routed to the new subscriber. Since both of the subscribers use different protocols, the signaling is translated by means of an Interworking Unit IWP.

Both subscribers RT, SIP will now find that two different requests BICC APM, BICC APM1 and UPDATE offer, UPDATE offer 1 exist for redirecting the basic channel, thereby creating a potential conflict.

According to the invention, this problem is solved in that each of the two subscribers sends the respective call partner a request BICC APM3, 500 (retry after) for delayed execution of the redirection of the basic channel.

Because the delay times differ, the conflict is resolved in a simple manner without the need for resource-intensive measures.

The described exemplary sequence is repeated below in tabular format, including detailed specifications of the signaling procedures:

| RT | IWP | SIP |
|---|---|---|
| BICC APM with | | |
| action indicator | | |
| “bearer redirect” | | |
| bearer redirection | | |
| indicator with | | |
| “Redirect Backwards | | |
| Request” or | | |
| “Redirect Forwards | | |
| Request” as per | | |
| Q.765.5/1902.6 [symbol] | | |
| [symbol] BICC APMA with | | |
| action indicator | | |
| “Connect Backward” | | |
| or “Connect | | |
| Forward” as per | | |
| Q.765.5/1902.6 . . . | | |
| BICC APMB with | [symbol] | UPDATE offer [symbol] |
| action indicator | | |
| “connect forward, | | |
| no notification” or | | |
| “connect forward, | | |
| plus notification” | | |
| or “connect | | |
| forward, no | | |
| notification + | | |
| selected codec” or | | |
| “connect forward, | | |
| plus notification + | | |
| selected codec” as | | |
| per Q.765.5/1902.6 | | |
| [symbol] | | |
| [symbol] BICC APM1 with | [symbol] | [symbol] UPDATE offer 1 |
| action indicator | | |
| “bearer redirect” | | |
| as per | | |
| Q.765.5/1902.6 | | |
| BICC APM2 with | [symbol] | [symbol] 500 (retry after) |
| action indicator | | |
| “bearer redirect” | | |
| and bearer | | |
| redirection | | |
| indicator “redirect | | |
| temporary reject” | | |
| as per | | |
| Q.765.5/1902.6 [symbol] | | |
| BICC APM3 with | [symbol] | [symbol] 500 (retry after) |
| action indicator | | |
| “bearer redirect” | | |
| and bearer | | |
| redirection | | |
| indicator “redirect | | |
| temporary reject” | | |
| as per | | |
| Q.765.5/1902.6 [symbol] | | |

An alternative sequence can appear as follows:

| RT | IWP | SIP |
|---|---|---|
| BICC APM with | | |
| action indicator | | |
| “bearer redirect” | | |
| bearer redirection | | |
| indicator with | | |
| “Redirect Backwards | | |
| Request” or | | |
| “Redirect Forwards | | |
| Request” as per | | |
| Q.765.5/1902.6 [symbol] | | |
| [symbol] BICC APMA with | | |
| action indicator | | |
| “Connect Backward” | | |
| or “Connect | | |
| Forward” as per | | |
| Q.765.5/1902.6 . . . | | |
| [symbol] BICC APM1 with | [symbol] | [symbol] UPDATE offer 1 |
| action indicator | | |
| “bearer redirect” | | |
| as per | | |
| Q.765.5/1902.6 | | |
| BICC APM3 with | [symbol] | [symbol] 500 (retry after) |
| action indicator | | |
| “bearer redirect” | | |
| and bearer | | |
| redirection | | |
| indicator “redirect | | |
| temporary reject” | | |
| as per | | |
| Q.765.5/1902.6 [symbol] | | |

A further implementation variant:

| RT | IWP | SIP |
|---|---|---|
| BICC APM with | | |
| action indicator | | |
| “bearer redirect” | | |
| bearer redirection | | |
| indicator with | | |
| “Redirect Backwards | | |
| Request” or | | |
| “Redirect Forwards | | |
| Request” as per | | |
| Q.765.5/1902.6 [symbol] | | |
| [symbol] BICC APMA with | | |
| action indicator | | |
| “Connect Backward” | | |
| or “Connect | | |
| Forward” as per | | |
| Q.765.5/1902.6 . . . | | |
| This message | [symbol] | [symbol] UPDATE offer 1 |
| optionally can be | | |
| sent/mapped or not | | |
| sent/mapped: | | |
| [symbol] BICC APM1 with | | |
| action indicator | | |
| “bearer redirect” | | |
| as per | | |
| Q.765.5/1902.6 | | |
| | [symbol] | [symbol] 500 (retry after) |
| BICC APMB with | [symbol] | UPDATE offer [symbol] |
| action indicator | | |
| “connect forward, | | |
| no notification” or | | |
| “connect forward, | | |
| plus notification” | | |
| or “connect | | |
| forward, no | | |
| notification + | | |
| selected codec” or | | |
| “connect forward, | | |
| plus notification + | | |
| selected codec” as | | |
| per Q.765.5/1902.6 | | |
| [symbol] | | |
| | | [symbol] 200 OK or 500 |
| | | with “retry after” |
| | | header |

The exemplary embodiment describes the case of a coincidence of the performance features “CALL Transfer” and “CALL Forwarding”. The advantages of the invention are particularly obvious in cases such as this.

However, the method according to the invention can also be applied in an identical or obviously similar manner to any case in which contradictory requirements in the protocol interworking result in a need for resolution when establishing or controlling a connection in packet-switched networks.

In particular, the invention is also not restricted to individual signaling protocols, interworking configurations or individual services in this case.

1.-6. (canceled)

7. A method for establishing a multimedia connection over packet-switching computer networks between a calling subscriber a called subscriber, comprising:
exchanging contradictory requirements between a calling subscriber and a called subscriber;
detecting the these contradictory requirements by the calling and the called subscribers; and
exchanging a request for delayed execution between the calling and called subscriber in response to detecting the contradictory requirements.

8. The method as claimed in claim 7, wherein the subscribers belong to domains having different signaling protocols, and that the signaling messages are routed via interworking points that perform a translation between the protocols of the signaling messages.

9. The method as claimed in claim 7, wherein a voice connection is set up as a multimedia connection.

10. The method as claimed in claim 7, wherein a fax connection is set up as a multimedia connection.

11. The method as claimed in claim 7, wherein a data connection which is routed via a modem is set up as a multimedia connection.

12. The method as claimed in claim 7, wherein a video connection is set up as a multimedia connection.

13. A method for establishing a multimedia connection over packet-switching computer networks, comprising:
providing a first subscriber using a first signaling protocol and having a first feature, wherein the first feature requires a rerouting of a first basic channel;
providing a second subscriber using a second signaling protocol and having a second feature, wherein the second feature requires a rerouting of a second basic channel;
exchanging signaling messages between the first and second subscriber via an interwork point that performs a translation between the protocols of the signaling messages;
detecting by the first subscriber that the second subscriber requires the rerouting of the second basic channel;
requesting a delayed execution in response to the detection by the first subscriber;
detecting by the second subscriber that the first subscriber requires the rerouting of the second first channel; and
requesting a delayed execution in response to the detection by the second subscriber.

14. The method as claimed in claim 13, wherein the first feature is a call transfer feature.

15. The method as claimed in claim 13, wherein the second feature is a call forwarding feature.

16. The method as claimed in claim 13, wherein a voice connection is set up as a multimedia connection.

17. The method as claimed in claim 13, wherein a fax connection is set up as a multimedia connection.

18. The method as claimed in claim 13, wherein a data connection which is routed via a modem is set up as a multimedia connection.

19. The method as claimed in claim 13, wherein a video connection is set up as a multimedia connection.
